(19) United States
(12) Patent Application Publication
(10) Pub. No.: US 2021/0354238 A1
(43) Pub. Date: Nov. 18, 2021

(54) LASER PROCESSING METHOD

(71) Applicant: DISCO CORPORATION, Tokyo (JP)

(72) Inventors: Masakazu KOBAYASHI, Tokyo (JP); Hajime SUZUKI, Tokyo (JP); Yuki OGAWA, Tokyo (JP)

(21) Appl. No.: 17/236,175

(22) Filed: Apr. 21, 2021

(30) Foreign Application Priority Data
May 12, 2020 (JP) 2020-084041

(51) Int. Cl. B23K 26/0622; B23K 26/18; B23K 26/06; B23K 26/067

(52) U.S. Cl. CPC B23K 26/0622; B23K 26/18; B23K 2101/40; B23K 26/0648; B23K 26/067; B23K 26/0665

(57) ABSTRACT

For processing a workpiece held by a chuck table with branched pulsed laser beams, if it is assumed that branch intervals at which adjacent ones of the branched pulsed laser beams are spaced from each other on a surface of the workpiece are represented by L, a value calculated by dividing a processing feed speed at which the chuck table is moved with respect to a condensing lens by a processing feed unit by the frequency of the pulsed laser beam at a processing point where the branched pulsed laser beams are applied to the workpiece is represented by S, and any integer is represented by n, then the branching intervals, the processing feed speed, and the frequency of the pulsed laser beam are established to satisfy the relationship of L≠n×S.

### BACKGROUND OF THE INVENTION

### Field of the Invention

The present invention relates to a laser processing method.

### Description of the Related Art

There have been known in the art a cutting method for dividing a plate-shaped workpiece such as a semiconductor wafer by rotating a cutting blade and moving the rotating cutting blade to cut into the plate-shaped workpiece and a laser processing method for dividing a plate-shaped workpiece by applying a pulsed laser beam that is absorbable by the plate-shaped workpiece to the plate-shaped workpiece, as processes for dividing plate-shaped workpieces along streets or projected dicing lines thereon into chips (see, for example, Japanese Patent Laid-open No. Hei 4-99607 and Japanese Patent Laid-open No. 2004-188475).

The laser processing method is advantageous in that since the width of grooves formed in the plate-shaped workpiece by the pulsed laser beam is larger than the width of grooves formed in the plate-shaped workpiece by the cutting blade, the streets on the plate-shaped workpiece can be made narrower, increasing the number of chips produced from the plate-shaped workpiece.

### SUMMARY OF THE INVENTION

However, the laser processing method is problematic in that thermal damage caused to the plate-shaped workpiece by the pulsed laser beam applied to process the plate-shaped workpiece along the streets tends to lower the flexural strength of semiconductor devices on the chips divided from the plate-shaped workpiece.

It is therefore an object of the present invention to provide a laser processing method that is capable of restraining a reduction in the flexural strength of semiconductor devices on chips divided from a workpiece.

In accordance with an aspect of the present invention, there is provided a laser processing method a method of processing a workpiece using a laser processing apparatus including a pulsed laser beam applying unit having a laser oscillator for emitting a pulsed laser bream having a wavelength that is absorbable by the workpiece, a condensing lens for focusing the pulsed laser beam emitted from the laser oscillator, and a branching unit disposed between the laser oscillator and the condensing lens, for branching the pulsed laser beam into a plurality of pulsed laser beams, a chuck table for holding the workpiece thereon, and a processing feed unit for moving the chuck table and the condensing lens relatively to each other in a processing feed direction, the method including a laser processing step of applying the pulsed laser beams branched in the processing feed direction by the branching unit through the condensing lens to the workpiece held on the chuck table while the chuck table is being processed and fed in the processing feed direction with respect to the condensing lens, in which, in the laser processing step, if it is assumed that branch intervals at which adjacent ones of the branched pulsed laser beams are spaced from each other on a surface of the workpiece are represented by L, a value calculated by dividing a processing feed speed at which the chuck table is moved with respect to the condensing lens by the processing feed unit by a frequency of the pulsed laser beam at a processing point where the branched pulsed laser beams are applied to the workpiece is represented by S, and any integer is represented by n, the branching intervals, the processing feed speed, and the frequency are established to satisfy a relationship of L≠n×S.

According to the present invention, the laser processing method is effective to restrain the flexural strength of semiconductor devices divided from the workpiece from being reduced.

The above and other objects, features and advantages of the present invention and the manner of realizing them will become more apparent, and the invention itself will best be understood from a study of the following description and an appended claim with reference to the attached drawings showing a preferred embodiment of the invention.

### BRIEF DESCRIPTION OF THE DRAWINGS

FIG. 1 is a perspective view of a workpiece as a target to be processed by a laser processing method according to an embodiment of the present invention;

FIG. 2 is a side elevational view, partly in cross section, schematically illustrating a configuration example of a laser processing apparatus that is used to carry out the laser processing method according to the embodiment;

FIG. 3 is an enlarged fragmentary plan view of a portion of a face side of the workpiece illustrated in FIG. 2;

FIG. 4 is a schematic diagram of a processed line produced on a workpiece by branched pulsed laser beams in the laser processing method according to the embodiment;

FIG. 5 is a schematic diagram of the processed line illustrated in FIG. 4 as disintegrated into separate focused laser beam spots in an indexing feed direction;

FIG. 6 is a schematic diagram of a processed line produced on a workpiece by branched pulsed laser beams according to a comparative example; and

FIG. 7 is a schematic diagram of the processed line illustrated in FIG. 6 as disintegrated into separate focused laser beam spots in an indexing feed direction.

### DETAILED DESCRIPTION OF THE PREFERRED EMBODIMENT

An embodiment of the present invention will hereinafter be described in detail with reference to the drawings. The present invention is not limited to the details of the embodiment described below. The components described below cover those which could easily be anticipated by those skilled in the art and those which are essentially identical to those described above. Furthermore, the arrangements described below can be combined in appropriate manners. Various omissions, replacements, or changes of the arrangements may be made without departing from the scope of the present invention.

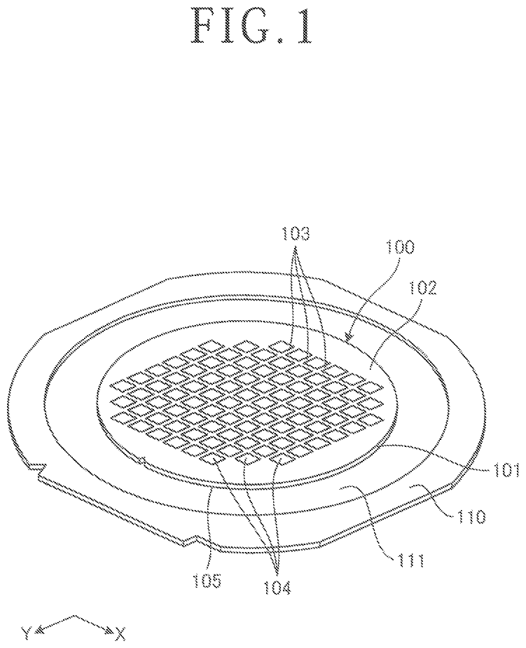

A laser processing method according to the present embodiment for processing a workpiece will be described in detail below with reference to the drawings. FIG. 1 illustrates in perspective a workpiece 100 as a target to be processed by the laser processing method according to the present embodiment. In the description given below and the drawings, an X-axis direction refers to a direction in a horizontal plane, whereas a Y-axis direction refers to a direction perpendicular to the X-axis direction in the horizontal plane.

As illustrated in FIG. 1, the workpiece 100 is in the form of a wafer such as a semiconductor wafer or an optical device wafer shaped as a circular plate including a substrate 101 made of silicon (Si), sapphire (Al₂O₃), gallium arsenide (GaAs), silicon carbide (SiC), or the like. The workpiece 100 has a grid of projected dicing lines or streets 103 established on a face side 102, facing upwardly, of the substrate 101 and a plurality of devices 104 formed in respective areas demarcated on the face side 102 by the projected dicing lines 103. The devices 104 may include circuits such as ICs, i.e., integrated circuits or LSI circuits, i.e., large scale integration circuits, or image sensors such as CCDs, i.e., charge-coupled devices or CMOSs, i.e., complementary metal oxide semiconductors. Therefore, the devices 104 may also be referred to as semiconductor devices.

The workpiece 100 is supported on an adhesive tape 111 attached to an annular frame 110. The annular frame 110 has a circular opening defined therein that is larger in diameter than the workpiece 100. The adhesive tape 111 has an outer circumferential area affixed to a reverse side, facing downwardly, of the annular frame 110. The workpiece 100 is positioned at a predetermined position in the circular opening of the annular frame 110 and has a reverse side 105 affixed to a face side, facing upwardly, of the adhesive tape 111. The workpiece 100 is thus fixed to the annular frame 110 and the adhesive tape 111.

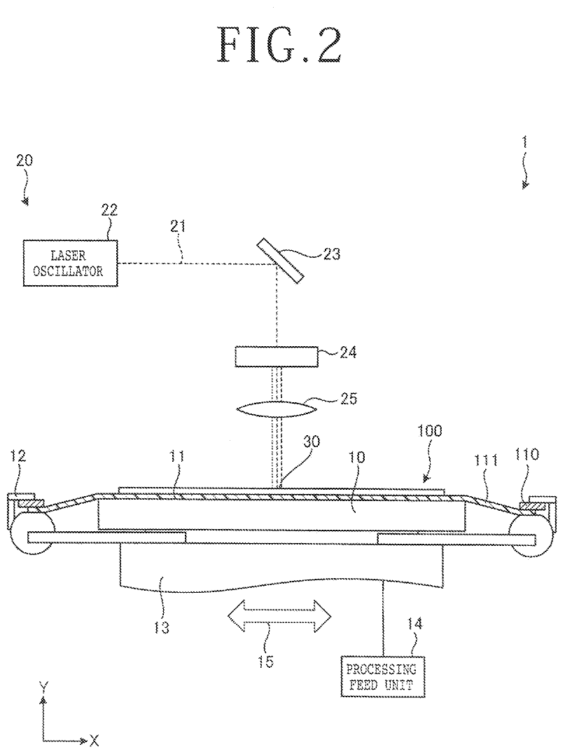

Next, the configuration of a laser processing apparatus 1 (see FIG. 2) that is used to carry out the laser processing method according to the present embodiment will be described below. FIG. 2 schematically illustrates, in side elevation, partly in cross section, a configuration example of the laser processing apparatus 1. In the description given below and the drawings, a Z-axis direction refers to a direction perpendicular to the X-axis direction and the Y-axis direction. On the laser processing apparatus 1 according to the present embodiment, a processing feed direction is represented by the X-axis direction, an indexing feed direction is represented by the Y-axis direction, and a focused spot position adjusting direction is represented by the Z-axis direction.

The laser processing apparatus 1 has a chuck table 10, a processing feed unit 14, and a pulsed laser beam applying unit 20. The laser processing apparatus 1 is an apparatus for processing the workpiece 100 by applying a pulsed laser beam 21 to the workpiece 100 as a target to be processed placed on the chuck table 10.

The chuck table 10 has a holding surface 11, facing upwardly, that holds the workpiece 100 thereon. The holding surface 11 is made of porous ceramic or the like and is of a disk shape. The holding surface 11 is connected to a vacuum source through a vacuum suction channel, for example. The chuck table 10 holds the workpiece 100 placed on the holding surface 11 under suction.

A plurality of clamps 12 for gripping the annular frame 110 that supports the workpiece 100 through the adhesive tape 111 are disposed at angularly spaced intervals around the chuck table 10. The chuck table 10 is rotated about a vertical axis parallel to the Z-axis direction by a rotating unit 13. The rotating unit 13 rotates the chuck table 10 to bring a desired one of the projected dicing lines on the workpiece 100 into alignment with the processing feed direction represented by the X-axis direction. The rotating unit 13 is supported on a processing feed unit 14.

The processing feed unit 14 moves the chuck table 10 and the pulsed laser beam 21 applied from the pulsed laser beam applying unit 20 relatively to each other along the processing feed direction. According to the present embodiment, specifically, the processing feed unit 14 moves the rotating unit 13 and the chuck table 10 along the X-axis direction representing the processing feed direction and the Y-axis direction representing the indexing feed direction. An arrow 15 in FIG. 2 indicates the directions in which the chuck table 10 is processing-fed by the processing feed unit 14.

The pulsed laser beam applying unit 20 is a unit for applying the pulsed laser beam 21 to the workpiece 100 held on the chuck table 10. As illustrated in FIG. 2, the pulsed laser beam applying unit 20 includes a laser oscillator 22, a mirror 23, a beam branching unit 24, and a condensing lens 25.

The laser oscillator 22 emits the pulsed laser beam 21 that has a predetermined wavelength for processing the workpiece 100. Specifically, the laser oscillator 22 emits the pulsed laser beam 21 that has a wavelength of 355 nm, for example, that is absorbable by the workpiece 100. The laser oscillator 22 emits the pulsed laser beam 21 as pulses at a preset frequency.

The mirror 23 reflects the pulsed laser beam 21 emitted from the laser oscillator 22 toward the workpiece 100 held on the holding surface 11 of the chuck table 10. According to the present embodiment, specifically, the mirror 23 reflects the pulsed laser beam 21 emitted from the laser oscillator 22 to the beam branching unit 24.

The pulsed laser beam 21 emitted from the laser oscillator 22 and reflected by the mirror 23 is applied to the beam branching unit 24. The beam branching unit 24 branches the applied pulsed laser beam 21 into at least two pulsed laser beams 21 that are transmitted through the beam branching unit 24 toward the condensing lens 25. The beam branching unit 24 branches the applied pulsed laser beam 21 along the processing feed direction. The beam branching unit 24 includes a diffractive optical element, for example. The diffractive optical element has a function to branch the applied pulsed laser beam 21 into a plurality of successive pulsed laser beams by way of diffraction.

The condensing lens 25 focuses the pulsed laser beam 21 emitted from the laser oscillator 22 onto the workpiece 100 held on the holding surface 11 of the chuck table 10. According to the present embodiment, specifically, the condensing lens 25 focuses the pulsed laser beams 21 branched along the processing feed direction by the beam branching unit 24 as focused laser beam spots 30 onto the workpiece 100.

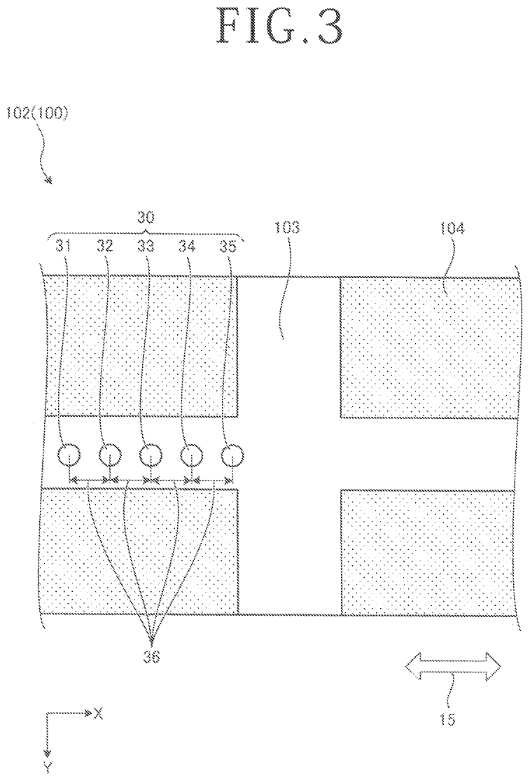

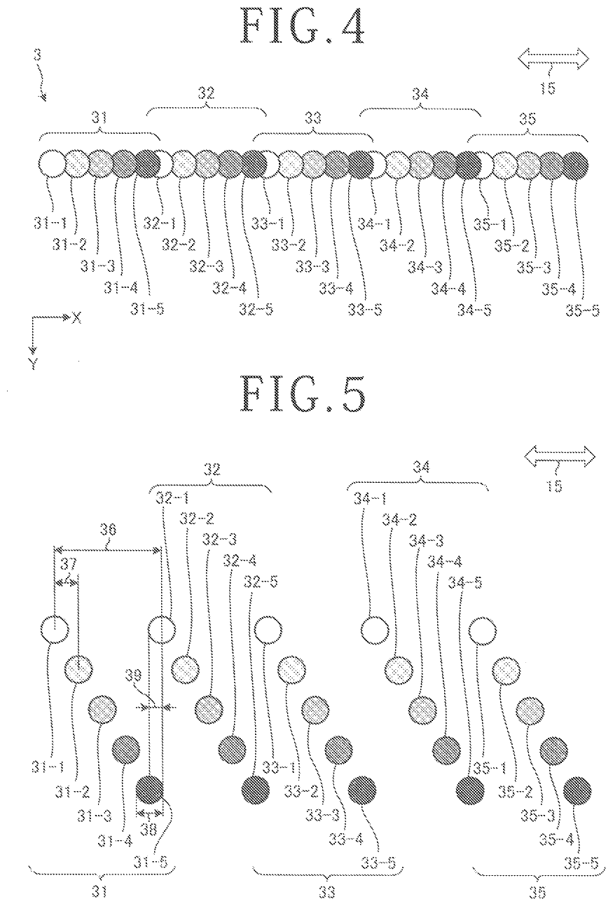

Next, the laser processing method according to the present embodiment will be described below. FIG. 3 illustrates in enlarged fragmentary plan a portion of the face side 102 of the workpiece 100 illustrated in FIG. 2. FIG. 4 schematically illustrates a processed line 3 produced on the workpiece 100 by the branched pulsed laser beams in the laser processing method according to the embodiment. FIG. 5 schematically illustrates the processed line 3 illustrated in FIG. 4 as disintegrated into separate focused laser beam spots in the indexing feed direction.

As illustrated in FIG. 3, when the workpiece 100 is processed by the branched pulsed laser beams along a projected dicing line 103 on the face side 102 of the workpiece 100, the branched pulsed laser beams 21 are applied as respective focused laser beam spots 30 positioned on the projected dicing line 103. The focused laser beam spots 30 are arrayed linearly at equal spaced intervals in the X-axis direction as the processing feed direction on the projected dicing line 103 on the face side 102 of the workpiece 100. In the example illustrated in FIGS. 3 through 5, specifically, the pulsed laser beam 21 emitted from the laser oscillator 22 is branched into five pulsed laser beams by the beam branching unit 24. In other words, as illustrated in FIG. 3, the focused laser beam spots 30 include five focused laser beam spots 31, 32, 33, 34, and 35 spaced apart in the X-axis direction as the processing feed direction.

As described above, the pulsed laser beam 21 is emitted as pulses at a preset frequency. In the laser processing method according to the present embodiment, one pulse of the pulsed laser beam 21 is branched into five pulses, forming the five focused laser beam spots 31, 32, 33, 34, and 35 on the projected dicing line 103 on the face side 102 of the workpiece 100. In other words, the branched pulses of the pulsed laser beam 21 are applied as a plurality of, five according to the present embodiment, focused laser beam spots 31, 32, 33, 34, and 35 to the projected dicing line 103 on the face side 102 of the workpiece 100. Therefore, one pulse of the pulsed laser beam 21 is branched into a plurality of, i.e., five according to the present embodiment, pulses that are applied as a plurality of focused laser beam spots 30, i.e., five focused laser beam spots 31, 32, 33, 34, and 35 according to the present embodiment, to the face side 102 of the workpiece 100.

Adjacent ones of the focused laser beam spots 31, 32, 33, 34, and 35 are spaced from each other by equal branch intervals 36. As illustrated in FIG. 3, the branch intervals 36 represent respective distances between the centers of adjacent ones of the focused laser beam spots 31, 32, 33, 34, and 35 formed on the projected dicing line 103 on the face side 102 of the workpiece 100. The branched pulsed laser beams 21 will hereinafter be also referred to as first, second, third, fourth, and fifth branches from the left in FIGS. 3 through 5.

While the branched pulsed laser beams 21 are being applied to a processing point on the face side 102 of the workpiece 100, the chuck table 10 illustrated in FIG. 2 is processing-fed in the processing feed direction, forming a processed line 3 on the face side 102 of the workpiece 100, as illustrated in FIG. 4. The pulsed laser beam 21 emitted from the laser oscillator 22 is applied as pulses at a preset frequency to the workpiece 100. Consequently, the processed line 3 is made up of a plurality of focused laser beam spots 30 spaced by shot intervals 37 (see FIG. 5) that are calculated by dividing a preset processing feed speed of the processing feed unit 14 (see FIG. 2) by the frequency of the pulsed laser beam 21.

As illustrated in FIG. 5, the shot intervals 37 indicate the respective distances between the centers of the focused laser beam spots 31, 32, 33, 34, and 35 formed on the projected dicing line 103 on the face side 102 of the workpiece 100 by a pulse of the pulsed laser beam 21 and a next pulse of the pulsed laser beam 21. For example, a shot interval 37 indicates the distance between the center of a focused laser beam spot 31-1 formed on the projected dicing line 103 on the face side 102 of the workpiece 100 by a first pulse, also referred to as a first shot, of the pulsed laser beam 21 and the center of a focused laser beam spot 31-2 formed on the projected dicing line 103 on the face side 102 of the workpiece 100 by a second pulse, also referred to as a second shot, of the pulsed laser beam 21.

According to the present embodiment, the shot intervals 37 are smaller than the beam diameters, denoted by 38, of the pulsed laser beams 21 that form the focused laser beam spots 30. In other words, focused laser beam spots 31-1, 32-1, 33-1, 34-1, and 35-1 formed by the first shot of the pulsed laser beam 21 and focused laser beam spots 31-2, 32-2, 33-2, 34-2, and 35-2 formed by the second shot of the pulsed laser beam 21 overlap each other, respectively. Focused laser beam spots formed by second and third shots of pulsed laser beams 21, third and fourth shots of pulsed laser beams 21, and fourth and fifth shots of pulsed laser beams 21 similarly overlap each other, respectively.

In the example illustrated in FIGS. 4 and 5, if it is assumed with respect to the processed line 3 that the branch intervals 36 are represented by L, the shot intervals 37 by S, and any integer by n, then L≠n×S. The shot intervals 37 are expressed by S=V/f where V represents the processing feed speed of the processing feed unit 14 and f the frequency of the pulsed laser beam 21 at the processing point on the face side 102 of the workpiece 100. Therefore, the branch intervals 36 represented by L, the processing feed speed V of the processing feed unit 14, and the frequency f of the pulsed laser beam 21 at the processing point are established to satisfy the relationship of L≠n×V/f.

Of the processed line 3, the focused laser beam spot 31-5 formed by the first branch of the fifth shot of the pulsed laser beam 21 overlap the focused laser beam spot 32-1 formed by the second branch of the first shot of the pulsed laser beam 21 by a predetermined overlap width 39. The overlap width 39 represents the length in the processing feed direction indicated by the arrow 15 of each of the overlapping portions of the focused laser beam spots 31, 32, 33, 34, and 35 formed by different pulses of the pulsed laser beams 21.

An overlapping percentage (%), defined below, should preferably be smaller than 80% for increasing the flexural strength of the devices 104 on the chips divided from the workpiece 100. The overlapping percentage is calculated by P=W/D×100 where P represents the overlapping percentage, D the beam diameter 38 of the focused laser beam spots 31, 32, 33, 34, and 35 formed by the branched pulsed laser beams 21, and W the overlap width 39. In other words, in the laser processing method according to the present invention, it is desirable that the branch intervals 36, the processing feed speed, and the frequency of the pulsed laser beam 21 be established to satisfy the relationship of 0≤P<80. If the overlapping percentage is 80% or higher (P≥80), then since the workpiece 100 tends to be overheated by the applied pulsed laser beam 21, the flexural strength of the flexural strength of the devices 104 on the chips divided from the workpiece 100 may possibly be reduced.

In the laser processing method according to the present invention, the overlapping percentage may be 0% (P=0). The overlapping percentage of 0% means that adjacent ones of the focused laser beam spots formed by the branches do not overlap each other. With the overlapping percentage of 0%, since the workpiece 100 is prevented from being overheated by the applied pulsed laser beam 21, the flexural strength of the devices 104 on the chips divided from the workpiece 100 is prevented from being reduced. If the overlapping percentage is smaller than 0% (P<0), then it means that the distances between the centers of adjacent ones of the focused laser beam spots formed by the branches are larger than the beam diameters 38, so that the adjacent ones of the focused laser beam spots are spaced apart from each other. In a case where the overlapping percentage is smaller than 0% (P<0), the processed line 3 is discontinuous and is made up of discrete focused laser beam spots. When the workpiece 100 is divided into chips along the discontinuous processed line 3, stresses tend to concentrate excessively on the workpiece 100, possibly reducing the flexural strength of the devices 104 on the chips divided from the workpiece 100. Consequently, in the laser processing method according to the present invention, it is desirable that the branch intervals 36, the processing feed speed, and the frequency of the pulsed laser beam 21 be established to satisfy the relationship of P≥0.

The focused laser beam spot 32-5 formed by the second branch of the fifth shot of the pulsed laser beam 21 and the focused laser beam spot 33-1 formed by the third branch of the first shot of the pulsed laser beam 21, the focused laser beam spot 33-5 formed by the third branch of the fifth shot of the pulsed laser beam 21 and the focused laser beam spot 34-1 formed by the fourth branch of the first shot of the pulsed laser beam 21, and the focused laser beam spot 34-5 formed by the fourth branch of the fifth shot of the pulsed laser beam 21 and the focused laser beam spot 35-1 formed by the fifth branch of the first shot of the pulsed laser beam 21 similarly overlap each other, respectively, with the overlapping percentage P≥0.

The laser processing apparatus 1 used to carry out the laser processing method according to the present embodiment includes a controller for controlling the various components of the laser processing apparatus 1 and an input unit for accepting laser processing conditions set by the user. When the user sets values of two parameters among the branch intervals 36 of the branched pulsed laser beams 21, the processing feed speed of the processing feed unit 14, and the frequency of the pulsed laser beam 21 at the processing point, the controller calculates a value of the remaining parameter that satisfies the equation: L=n×V/f. The operator can set the remaining parameter excluding the calculated values.

The laser processing apparatus 1 may further include an alarm device for issuing predetermined alarm information when the set values of the branch intervals 36 of the branched pulsed laser beams 21, the processing feed speed of the processing feed unit 14, and the frequency of the pulsed laser beam 21 satisfy the equation: L=n×V/f.

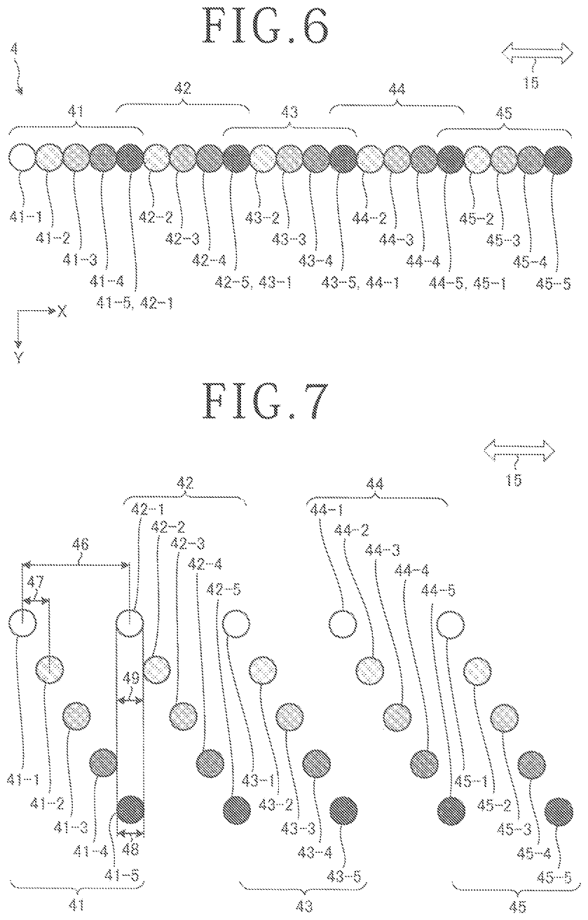

Now, a processed line 4 produced by branched pulsed laser beams 21 according to a comparative example will be described below. FIG. 6 schematically illustrates the processed line 4 produced on a workpiece by the branched pulsed laser beams 21 according to the comparative example. FIG. 7 schematically illustrates the processed line 4 illustrated in FIG. 6 as disintegrated into separate focused laser beam spots in an indexing feed direction.

In the comparative example illustrated in FIGS. 6 and 7, the pulsed laser beam 21 is branched into five pulsed laser beams to form five focused laser beam spots 41, 42, 43, 44, and 45 on the workpiece that are spaced apart in the X-axis direction as the processing feed direction. Adjacent ones of the focused laser beam spots 41, 42, 43, 44, and 45 are spaced from each other by equal branch intervals 46. The pulsed laser beam 21 is applied as pulses at a preset frequency to the workpiece. The processed line 3 is made up of a plurality of focused laser beam spots 41, 42, 43, 44, and 45 spaced by shot intervals 47 (see FIG. 7) that are calculated by dividing a preset processing feed speed of the processing feed unit 14 (see FIG. 2) by the frequency of the pulsed laser beam 21.

It is assumed with respect to the processed line 4 that the branch intervals 46 are represented by L, the shot intervals 47 by S, and any integer by n, then L=n×S. The shot intervals 47 are expressed by Sc=V/f where V represents the processing feed speed of the processing feed unit 14 and f the frequency of the pulsed laser beam 21 at the processing point. Therefore, the branch intervals 46 represented by L, the processing feed speed V of the processing feed unit 14, and the frequency f of the pulsed laser beam 21 at the processing point are established to satisfy the relationship of Lc=n×V/f.

Of the processed line 4, the focused laser beam spot 41-5 formed by the first branch of the fifth shot of the pulsed laser beam 21 overlap the focused laser beam spot 42-1 formed by the second branch of the first shot of the pulsed laser beam 21 by a predetermined overlap width 49. According to the comparative example, the overlapping percentage of these focused laser beam spots is 100%. The overlapping percentage is calculated by P=W/D where P represents the overlapping percentage, D the beam diameter 48 of the focused laser beam spots 41, 42, 43, 44, and 45 formed by the branched pulsed laser beams 21, and W the overlap width 49.

The focused laser beam spot 42-5 formed by the second branch of the fifth shot of the pulsed laser beam 21 and the focused laser beam spot 43-1 formed by the third branch of the first shot of the pulsed laser beam 21, the focused laser beam spot 43-5 formed by the third branch of the fifth shot of the pulsed laser beam 21 and the focused laser beam spot 44-1 formed by the fourth branch of the first shot of the pulsed laser beam 21, and the focused laser beam spot 44-5 formed by the fourth branch of the fifth shot of the pulsed laser beam 21 and the focused laser beam spot 45-1 formed by the fifth branch of the first shot of the pulsed laser beam 21 overlap each other, respectively. The overlapping percentage of these focused laser beam spots is 100%.

In the laser processing method according to the present embodiment, as described above, the branch intervals 36 represented by L, the processing feed speed V of the processing feed unit 14, and the frequency f of the pulsed laser beam 21 at the processing point are established to satisfy the relationship of L≠n×S where S represents the shot intervals 37 and n ay integer.

According to the comparative example, when the pulsed laser beam 21 branched in the processing feed direction is applied to process the workpiece, the focused laser beam spot 41-5 formed by the first branch of the n-th shot, i.e., the fifth shot, of the branched pulsed laser beam 21 fully overlaps the focused laser beam spot 42-1 formed by the second branch of the first shot of the branched pulsed laser beam 21 on the processed line 4 where L=n×S. Since the two focused laser beam spots are formed at one position, the pulsed laser beam 21 applied to the workpiece at the position causes increased thermal damage to the workpiece, possibly lowering the flexural strength of the semiconductor devices on the chips divided from the workpiece.

On the processed line 3 according to the embodiment, however, the focused laser beam spot 31-5 formed by the first branch of the n-th shot, i.e., the fifth shot, of the branched pulsed laser beam 21 partly overlaps, but not fully overlaps, the focused laser beam spot 32-1 formed by the second branch of the first shot of the branched pulsed laser beam 21 on the processed line 3. In other words, by establishing the branch intervals 36 represented by L, the processing feed speed V of the processing feed unit 14, and the frequency f of the pulsed laser beam 21 at the processing point to satisfy the relationship of L≠n×S, the focused laser beam spot 31-5 formed by the first branch of the n-th shot of the branched pulsed laser beam 21 and the focused laser beam spot 32-1 formed by the second branch of the first shot of the branched pulsed laser beam 21 are prevented from fully overlapping each other. Inasmuch as thermal damage caused to the workpiece 100 by the pulsed laser beam 21 can be reduced by reducing the overlap width 39 by which adjacent focused laser beam spots overlap each other, the flexural strength of the devices 104 is restrained from being reduced.

The present invention is not limited to the embodiment described above. Various changes and modifications may be made therein without departing from the scope of the invention.

For example, the laser processing conditions in the laser processing method are not limited to those described above in the embodiment. In a case where the substrate 101 of the workpiece 100 is made of silicon and has a thickness of 50 μm, the laser processing conditions may be set to the following values, for example:
Number of branches: 2 through 32
Branch intervals: 10 through 400 μm
Spot diameter: 3 through 10 μm
Wavelength: 355 nm
Frequency: 100 kHz
Power: 7.5 kW
Number of passes: 30 passes

Processing feed speed: 10 through 2000 mm/s

The present invention is not limited to the details of the above described preferred embodiment. The scope of the invention is defined by the appended claim and all changes and modifications as fall within the equivalence of the scope of the claim are therefore to be embraced by the invention.

What is claimed is:

1. A method of processing a workpiece using a laser processing apparatus including a pulsed laser beam applying unit having a laser oscillator for emitting a pulsed laser bream having a wavelength that is absorbable by the workpiece, a condensing lens for focusing the pulsed laser beam emitted from the laser oscillator, and a branching unit disposed between the laser oscillator and the condensing lens, for branching the pulsed laser beam into a plurality of pulsed laser beams, a chuck table for holding the workpiece thereon, and a processing feed unit for moving the chuck table and the condensing lens relatively to each other in a processing feed direction, the method comprising:
a laser processing step of applying the pulsed laser beams branched in the processing feed direction by the branching unit through the condensing lens to the workpiece held on the chuck table while the chuck table is being processed and fed in the processing feed direction with respect to the condensing lens,
wherein, in the laser processing step, if it is assumed that branch intervals at which adjacent ones of the branched pulsed laser beams are spaced from each other on a surface of the workpiece are represented by L, a value calculated by dividing a processing feed speed at which the chuck table is moved with respect to the condensing lens by the processing feed unit by a frequency of the pulsed laser beam at a processing point where the branched pulsed laser beams are applied to the workpiece is represented by S, and any integer is represented by n, the branching intervals, the processing feed speed, and the frequency are established to satisfy a relationship of L≠n×S.
